(19) United States
(12) Patent Application Publication
(10) Pub. No.: US 2026/0036478 A1
(43) Pub. Date: Feb. 5, 2026

(54) METHOD AND DEVICE FOR DETECTING TORQUE ANOMALIES IN A ROLLING BEARING

(71) Applicant: AKTIEBOLAGET SKF, Goteborg (SE)

(72) Inventor: Marco Giovanni Francesco CAPOZZI, Torino (IT)

(21) Appl. No.: 19/266,221

(22) Filed: Jul. 11, 2025

(30) Foreign Application Priority Data
Jul. 30, 2024 (IT) 102024000017695

(51) Int. Cl. G01L 5/00

(52) U.S. Cl. CPC G01L 5/0019

(57) ABSTRACT

A method for automatically detecting free torque anomalies in a rolling bearing includes: a) securing the first ring to a stationary support, b) mechanically connecting a first drag element to the second ring, the first drag element being configured to rotate the second ring relative to the first ring when operated upon by an outside force, c) using a motor-actuated second drag element operatively connected to the first drag element to rotate the first drag element at a first predetermined angular speed about the axis of rotation at least 360° clockwise and counterclockwise, d) generating an electrical signal indicative of a mechanical force between the first drag element and the second drag elements during the step c, and e) processing the electrical signal to calculate free torque values of the rolling bearing during rotation.

### CROSS-REFERENCE

This application claims priority to Italian patent application no. 10 2024000017695 filed on Jul. 30, 2024, the contents of which are fully incorporated herein by reference.

### TECHNOLOGICAL FIELD

The present disclosure relates to a method and to an associated device for detecting torque anomalies, known in the prior art as “Gorokan”, in a rolling bearing, in particular in super precision rolling bearings such as those used in aerospace applications.

### BACKGROUND

“Gorokan” is the name given to an anomaly found in rolling bearings, in particular rolling bearings used for super precision applications. The anomaly concerns what is referred to as the free torque of the rolling bearing, which instead of being substantially constant, may fluctuate unpredictably, in particular with changes in the direction of rotation of the rolling bearing.

“Gorokan” only affects some bearings, and is thought to be the result of structural micro-defects and/or dust or dirt or other micro-contaminants getting in, even to the slightest degree, past the sealing devices of the bearing, for example when it is being assembled.

Currently, testing is carried out manually. This leads to inconsistencies in the results detected, which depend on the dexterity of the operator and on many other subjective factors. Therefore, manual testing is highly subjective and may result in entire batches of rolling bearings being rejected by end users, with consequent unforeseen economic losses for bearing producers.

### SUMMARY

There is therefore a need for producers of rolling bearings to have an objective measuring system which can provide an electrical signal in terms of current or voltage that can be recorded and analyzed using suitable software, for example performing an FFT (Fast Fourier Transform) of the signal.

It is an aspect of the present disclosure to provide a detection method and an associated measuring device for detecting, objectively and reliably, free torque anomalies in a rolling bearing, and therefore without the drawbacks of the prior art. The present disclosure provides a detection method and an associated measuring device for detecting and/or determining, automatically and reliably, free torque anomalies in a rolling bearing.

More specifically, the disclosure comprises a method and an associated device that are configured to detect Gorokan automatically, repeatably and in an objectively measurable manner. The principle of measurement is to convert a fluctuation in the free torque of the rolling bearing into an electrical signal that can be easily analyzed. The principle of measurement reproduces, repeatably and objectively, the manual principle.

Since free torque, in other words the resistance to rotation provided by the rolling bearing, is very low, use is made of a magnetic coupling to rotate the bearing by 360° clockwise, then by 360° counterclockwise, with a speed of rotation ω such that the following relation holds:

$$0 < ω < 2 rpm . \qquad [ 1 ]$$

The free torque of the bearing is measured by a load cell or a piezoelectric material. Since the torque is applied to the outer ring via a magnetic coupling, it is possible to identify the slightest changes in torque. It is known that piezoelectric material converts a deformation into a current. The current can be read and plotted so as to analyze variations thereof throughout each 360° rotation. As soon as the Gorokan, in other words a fluctuation in free torque, is identified the signal, appropriately converted into a graph, will exhibit ripples, or peaks, thus indicating a defective bearing. For correct implementation of the method of the disclosure, the rolling bearing is loaded, when the rotations are being performed, with an axial force F preferably of between zero and 100 N, i.e. according to the relation:

$$0 < F < 100 N . \qquad [ 2 ]$$

### BRIEF DESCRIPTION OF THE DRAWINGS

The disclosure will now be described with reference to the attached drawings, which illustrate a non-limiting example of an embodiment of the disclosure, in which:

FIG. 1 is a schematic elevational view of a device for measuring Gorokan in a rolling bearing according to an embodiment of the disclosure.

FIG. 2 is a schematic plan view of the measuring device of FIG. 1 together with a number of accessory devices.

FIG. 3 a schematic example of a graphical signal depicts that may be generated by a method according to an embodiment of the disclosure.

### DETAILED DESCRIPTION

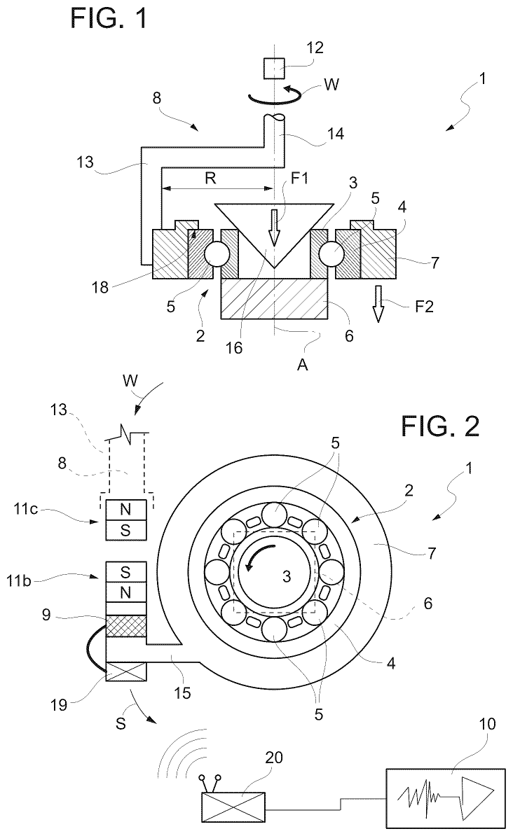

With reference to FIGS. 1 to 3, the reference numeral 1 generally designates a measuring device for automatically detecting and/or determining any free torque anomalies in a rolling bearing 2 of any known type and comprising a first ring 3, which in the example shown comprises a radially inner ring of the rolling bearing 2, a second ring 4, which in the example shown comprises a radially outer ring of the rolling bearing 2, and a plurality of rolling bodies 5 arranged between the first and second rings 3 and 4 to make them rotate relative to one another with low friction about an axis of relative rotation A that is a common axis of symmetry of the rings 3 and 4, which are arranged coaxially with each other.

The measuring device 1 comprises a stationary support 6 configured to receive the first ring 3 of the rolling bearing 2 which is angularly locked on the support 6 in such a way as to also hold the ring 3. The measuring device 1 further comprises a first drag element 7, which, as will be seen in more detail below is a driven transmission element, configured to receive angularly integral therewith the second ring 4 of the rolling bearing 2.

The measuring device 1 also comprises, according to one aspect of the disclosure, a second drag element 8 which, as will be seen in more detail below, is a motorized transmission element for driving the drag element 7.

The second drag element 8 is operatively associated with the first drag element 7 to rotate, at a first predetermined angular speed @, indicated in FIGS. 1 and 2 by an arrow, the first drag element 7 and, with it, the second ring 4 of the rolling bearing 2, about the axis A of symmetry and relative rotation of the first and second rings 3 and 4, respectively.

According to one aspect of the disclosure, the first drag element 7 is configured to rotate the ring 4 relative to the ring 3 clockwise (as indicated by the direction of the arrow W) and counterclockwise (i.e. in the opposite direction to that shown in FIGS. 1 and 2 by the arrow W), respectively.

According to the disclosure, the measuring device 1 also includes a detecting device 9 (FIG. 2) for detecting a mechanical stress, such as force or torque, exchanged between the first and the second drag element 7, 8 as a result of torque transmission from the second drag element 8 to the first drag element 7 to drag the latter into rotation. The detecting device 9 is configured to generate an electrical signal S (FIG. 2) responsive to the application of the mechanical stress on the first drag element, for example proportional to the thrust which the second drag element 8 exerts on the first drag element 7 in the method which will be explained below.

Lastly, the measuring device 1 comprises a processing unit 10 of any known type, for example a PLC or a computer with a microprocessor and special software, configured to receive the electrical signal S and calculate, in real time, free torque values of the rolling bearing 1 which are determined gradually during the rotation, both clockwise and counterclockwise, that is imparted to the second ring 4.

To be specific, the first and second drag elements 7, 8 are configured to rotate the second ring 4 (the radially outer ring 4 in the preferred example of an embodiment shown) of the rolling bearing 2 by at least one full 360° rotation in both clockwise and counterclockwise directions.

According to an important aspect of the disclosure, the first and second drag elements 7, 8 are operatively associated with one another to cause the transmission of torque and of rotation by the second drag element 8 to the first drag element 7 without mechanical contact.

To this end, the first and second drag elements are provided with respective magnets or electromagnets, 11b and 11c respectively (FIG. 2), facing each other and conjugated to each other, arranged at a predetermined radial distance R (FIG. 1) from the axis of relative rotation A and symmetry of the rings 3 and 4 of the rolling bearing 2.

In the non-limiting but preferred example of an embodiment of the disclosure shown in FIGS. 1 and 2, the magnets or electromagnets 11b and 11c of, respectively, the first and second drag elements 7 and 8 face each other and have identical polarity, such that the second drag element 8 is configured to push the first drag element 7 into rotation by magnetic repulsion.

Essentially, the motorized drag element 8 is connected to a motor, preferably an electric motor, 12, for example a stepper motor, and has a radial arm 13 which extends radially protruding from a hub 14 coaxial with the motor 12 and with the axis A and which bears at one free end the magnets/electromagnets 11c at the radial distance R from the axis of rotation A.

Consequently, in use, the motor 12 sets in rotation, for example under the control of the processing unit 10, the arm 13 of the drag element 8 at a relatively slow angular speed @ of between zero (arm 13 stationary) and, for example, 2 rpm, such that the following relation holds:

$$0 < ω < 2 rpm . \qquad [ 1 ]$$

The magnets 11c are therefore pushed towards the magnets 11b, of identical polarity, placed facing them in the direction of rotation imparted by the motor 12 (counterclockwise in FIG. 2), therefore “pushing” against the magnets 11b. The latter are in turn borne by the drag element 7 radially protruding from the axis A, again at the distance R from the latter, for example are mounted at the free end of a radial arm 15 which extends protruding from the drag element 7, radially on the outside thereof. Consequently, the drag element 7 is rotated in the counterclockwise direction by the drag element 8 and by its motor 12 without mechanical contact between the elements 7 and 8, making it possible to apply to the drag element 7 torques which are extremely low, precise and stable.

To perform a rotation clockwise, the arms 13 and 15 may be equipped with two sets of opposite magnets 11c, 11b with identical polarities facing one another but in the opposite direction, for example the arms 13,15 have fork shaped free ends (not shown for the sake of simplicity) each having a pair of magnets 11 of opposite polarities, and therefore when the rotation of the motor 12 is reversed the drag element 7 is also rotated in the opposite direction to previously, clockwise in the example shown.

Obviously, other configurations are possible. For example, the magnets 11b, 11c, rather than facing one another circumferentially about the axis A of rotation, could be axially facing and activated with opposite polarities, such that by rotating the drag element 8, this causes the drag element 7 to rotate with it.

In the configuration in which the magnets 11b, 11c are facing one another circumferentially, as in the non-limiting example shown; the detecting device 9 is carried by the first drag element 7 and comprises a load cell or a piezoelectric sensor mechanically coupled with a respective magnet or electromagnet or set of magnets/electromagnets 11b carried by the arm 15 of the first drag element 7.

In one possible configuration with the magnets 11b and 11c facing one another axially, the sensor 9 could be produced with extensometers connected via a bridge, again carried by the arm 15 directly in contact with/under the magnet/set of magnets 11b.

When the first ring to be kept stationary is the radially inner ring 3 of the rolling bearing 2, the ring 3 is arranged on a flat stationary support 6 with the axis of symmetry A oriented substantially vertical and the ring 3 is then angularly locked against the flat support 6, preferably by means of a device 16 for applying a predetermined axial thrust or load F1 (FIG. 1), preferably self-centering and depicted schematically as a conical pusher.

Likewise, when the ring to be rotated is the radially outer ring 4 of the rolling bearing 2, the ring 4 is angularly connected integrally to the drag element 7 which, in this case, comprises an annular bush which is fitted radially on the outside of the outer ring 4, coaxial with the outer ring 4, which is arranged with the axis of symmetry A oriented substantially vertical.

According to one aspect of the disclosure, the annular bush 7 constituting the first drag element is coupled axially in abutment against the outer ring 4, for example via an axial shoulder 18 formed on the annular bush 7, in such a way as to apply to the outer ring 4 to be rotated relatively, in this case by gravity, a predetermined second axial thrust or load F2, in the example shown resulting simply from the weight of the annular bush 7. Obviously other solutions are possible.

In any case, according to one aspect of the disclosure, the second axial thrust or load F2 must be below 250 N and, preferably, be between zero (for example the weight of the annular bush 7 is supported by an external element or the load F2 is not applied by gravity) and 100 N, i.e. the following relation must hold:

$$0 < F 2 < 100 N . \qquad [ 2 ]$$

It is clear from the above that the disclosure also extends to a method for automatically determining any free torque anomalies in a rolling bearing 2 comprising a first 3 and a second 4 ring arranged coaxially with each other and a plurality of rolling bodies 5 arranged between the first and second rings 3,4 to make them rotatable with low friction about an axis of relative rotation A consisting of a common axis of symmetry of the first and second rings 3,4.

The method according to the disclosure comprises the following steps: a) arranging the first ring 3 of the rolling bearing 2 on a stationary support 6 and clamping it onto the same; b) mechanically, angularly and integrally connect to the second ring 4 of the rolling bearing 2 the first, driven drag element 7, the first drag element 7 being configured such that it can drag the second ring 4 in relative rotation with respect to the first ring 3; c) rotating at a first predetermined angular speed w the first drag element 7 about the axis A of symmetry and relative rotation of the first and second rings 3, 4 by means of the motorized, driving, second drag element 8, operatively associated with the first drag element 7; the step is carried out by compelling the second ring 4 of the rolling bearing 2 to make at least one full 360° rotation in both clockwise and counterclockwise directions, d) detecting, by generation of an electrical signal S, a mechanical stress, torque or force, which the first and the second drag elements 7,8 necessarily exchange to put the first drag element 7 in rotation, and d) processing the electrical signal S (in the processing unit 10) to calculate free torque values of the rolling bearing 2 during all 360° of rotation of the second ring 4.

According to an important aspect of the disclosure, step is performed without direct physical contact between the first and second drag element 3,4, by magnetic or electromagnetic repulsion.

Preferably, as the first ring to be kept stationary, the radially inner ring 3 of the rolling bearing 2 is selected; in this case the inner ring 3 is arranged on a flat stationary support 6, with the axis of symmetry A oriented substantially vertical, and angularly locked against the flat support 6 by a device 16 for applying a predetermined first axial thrust F1.

According to this preferred embodiment, as the second ring to be rotated, the radially outer ring 4 of the rolling bearing 2 is selected; in this case, the first drag element comprises an annular bush 7 which is fitted radially on the outside of the outer ring 4, coaxial with the outer ring 4, which is arranged with the axis of symmetry A oriented substantially vertical. The annular bush 7 is moreover coupled axially in abutment against the outer ring 4 in such a way as to apply to the same by gravity a predetermined second axial thrust F2.

Again according to this embodiment, step is carried out by using a load cell or a piezoelectric sensor 9, carried radially on the outside by the first drag element or annular bush 7 at a predetermined distance R from the axis of symmetry and rotation A and operatively associated with a magnetic coupling device 11b, 11c between the first and second drag elements 7,8 to generate the electrical signal S, which in this case will be an electrical signal in terms of current.

Since the sensor 9 is carried by a rotating element such as the annular bush 7, step is performed by receiving the electrical signal S wirelessly, via Wi-Fi technology for example, in the processing unit 10, for example using a Wi-Fi transmitter 19 which transmits a radio signal to a Wi-Fi receiver 20 connected by cable to the processing unit 10.

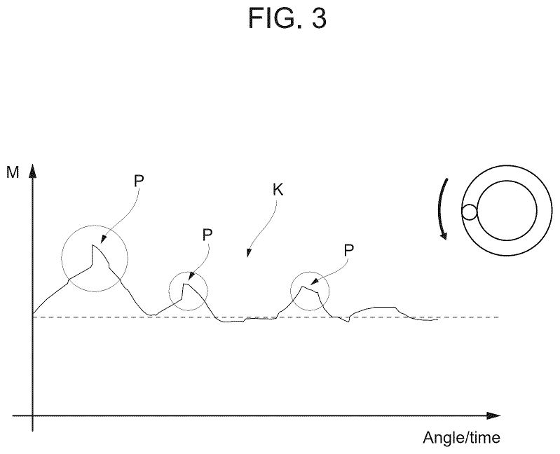

Preferably, the processing unit 10 is programmed to perform an FFT on the signal S, thus determining instant by instant (in real time) the free torque M of the rolling bearing 2 during its rotation and counter-rotation by 360°, providing a graphical signal K (FIG. 3) in which the presence of more or less pronounced peaks or ripples P signals the presence of free torque M fluctuations and, therefore the presence of Gorokan.

Lastly, it is clear that the same result could be obtained by producing a measuring device 1 in which it is the inner ring 3 to be rotated and the outer ring 4 to remain stationary, although this embodiment could be structurally more difficult to achieve. Likewise, the sensor 9 could be produced in such a way as to transmit a signal S in terms of voltage.

In any case, the whole of the measuring operation can be carried out entirely automatically, under the control of the processing unit 10, with high repeatability and in no way subjectively.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved method and device for detecting torque anomalies.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

What is claimed is:

1. A method for automatically detecting free torque anomalies in a rolling bearing having a first ring and a second ring arranged coaxially relative to each other and a plurality of rolling bodies arranged between the first ring and the second ring to permit relative rotation about a common axis of rotation, the method comprising:
a) securing the first ring to a stationary support,
b) mechanically connecting a first drag element to the second ring for fixed rotation with the second ring, the first drag element being configured, when acted upon by a driving force, to rotate the second ring relative to the first ring,
c) using a motor-actuated second drag element operatively connected to the first drag element to produce the driving force to rotate the first drag element at a first predetermined angular speed about the axis of rotation at least 360° in a clockwise direction and at least 360° in a counterclockwise direction,
d) generating an electrical signal indicative of a mechanical force between the first drag element and the second drag elements during the step c; and
e) processing the electrical signal to calculate free torque values of the rolling bearing during the 360° clockwise rotation of the second ring and/or during the 360° counterclockwise rotation of the second ring.

2. The method according to claim 1, wherein the step c) is performed without direct physical contact between the first drag element and the second drag element.

3. The method according to claim 1, wherein the first drag element and the second drag element each comprise a permanent magnet or an electromagnet.

4. The method according to claim 3,
wherein the first ring is a bearing inner ring,
wherein step a) comprises holding the first ring against the stationary support in a horizontal orientation by applying a predetermined first axial thrust against the first ring.

5. The method according to claim 4,
wherein the second ring is a bearing outer ring,
wherein the first drag element comprises an annular bush fitted on the radially outer portion of the outer ring such that the first drag element applies a predetermined second axial thrust against the outer ring.

6. The method according to claim 5,
wherein the step d) comprises generating the electrical signal from a load cell or a piezoelectric sensor connected to a location on a radially outer side of the first drag element at a predetermined distance from the axis of rotation.

7. The method according to claim 6,
including transmitting the electrical signal wirelessly from the load cell or piezoelectric sensor to a receiver connected to a computer.

8. The method according to claim 6,
wherein the step e) comprises performing an FFT of the electrical signal to determine the instantaneous free torque of the rolling bearing, and
providing a graphical signal in which a presence of peaks or ripples indicates a presence of free torque fluctuations.

9. A measuring device for automatically determining free torque anomalies in a rolling bearing having a first ring and a second ring arranged coaxially with each other with the first ring mounted on a stationary support and including a plurality of rolling bodies arranged between the first ring and the second ring to permit relative rotation of the first ring and the second rng about a common axis of rotation, the measuring device comprising:
a first drag element connectable to the second ring of the rolling bearing;
a second drag element operatively associated with the first drag element such that rotation of the second drag element causes the first drag element to rotate at a predetermined first angular speed in a clockwise direction and in a counterclockwise direction,
a detecting device configured to produce an electrical signal indicative of a mechanical force between the first drag element and the second drag element during the rotation of the second drag element, and
a processor configured to receive the electrical signal and calculate free torque values of the rolling bearing during the rotation of the second ring.

10. The device according to claim 9,
wherein the first and second drag elements are configured to rotate the second ring clockwise and counterclockwise by at least 360°.

11. The device according to claim 10,
wherein the first and second drag elements comprise magnets or electromagnets, and
wherein the first drag element is configured to rotate the second drag element without mechanical contact between the first drag element and the second drag element.

12. The device according to claim 11,
wherein the magnet or electromagnet of the first drag element has a same polarity as the magnet or electromagnet of the second drag element, and
wherein the detecting device is mounted on the first drag element and includes a load cell or piezoelectric sensor mechanically coupled with the magnet or electromagnet of the first drag element.

13. A system comprising:
a measuring device according to claim 9, and
the rolling bearing,
wherein the first ring of the bearing is an inner ring and is mounted on the stationary support,
wherein the first drag element is mounted on the first bearing ring, and
wherein the second drag element is mounted on the second bearing ring.
